(19) United States
(12) Patent Application Publication
(10) Pub. No.: US 2011/0208927 A1
(43) Pub. Date: Aug. 25, 2011

(54) VIRTUAL MEMORY

(76) Inventors: Donald J. McNamara, Woodinville, WA (US); Alexander F. Nagy, Seattle, WA (US)

(21) Appl. No.: 12/711,092

(22) Filed: Feb. 23, 2010

(51) Int. Cl. G06F 15/167; G06F 12/02

(52) U.S. Cl. 711/159; 709/213; 711/E12.002

(57) ABSTRACT

This document describes techniques and apparatuses enabling virtual memory for network-enabled computing devices. These techniques and apparatuses may enable network-enabled computing devices to avoid, or reduce the chances of, having little or no available memory.

### BACKGROUND

Internal memory capacity often limits the speed and functioning of computing devices. When a device's memory is full or has limited space, applications on the device may not run or may run slowly or poorly. To address this problem, users may purchase more internal memory, purchase external memory drives, and archive and then delete files from memory. Addressing this problem with more internal memory is limited by the device's ability to accept more internal memory and can be expensive. Addressing this problem with external memory drives is limited by the device's connections, and can be expensive and inconvenient. Addressing this through archiving is time-intensive and inconvenient, often requiring a user to search through files to archive, archive them, and then delete them. If the user doesn't do this regularly, the device may still run low on memory. Even if the user does go through this inconvenient process regularly, an application on the device that needs an archived file may fail to run or run improperly, possibly requiring the user to retrieve and resave the file—a further inconvenience.

### SUMMARY

This document describes techniques and apparatuses enabling virtual memory for network-enabled computing devices. In one embodiment, this virtual memory is nearly limitless, thereby permitting nearly unlimited use of memory by a network-enabled computing device. Further, these techniques and apparatuses may enable this virtual memory in a manner that is transparent to the user of, and even applications on, the network-enabled computing device.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit of a reference number identifies the figure in which the reference number first appears. The use of the same reference number in different instances in the description and the figures may indicate similar or identical items.

FIG. 1 illustrates an example environment having a virtual-memory device and a network-enabled computing device.

FIG. 2 illustrates example entities of the network-enabled computing device and virtual-memory device illustrated in FIG. 1.

FIG. 3 is a flow diagram depicting an example process for enabling virtual memory for a network-enabled computing device from the perspective of network-enabled computing device.

FIG. 4 is a flow diagram depicting an example process for enabling virtual memory for a network-enabled computing device including retrieving data stored remotely.

FIG. 5 is a flow diagram depicting an example process for enabling virtual memory for a network-enabled computing device from the perspective of a virtual-memory device.

### DETAILED DESCRIPTION

Overview

This document describes techniques and apparatuses enabling virtual memory for network-enabled computing devices. These techniques and apparatuses may enable network-enabled computing devices to avoid, or reduce the chances of, having little or no available memory. By so doing, a user of a network-enabled computing device may forgo various inconvenient, expensive, and/or impossible-to-perform fixes to his device's limited memory.

Example Environment

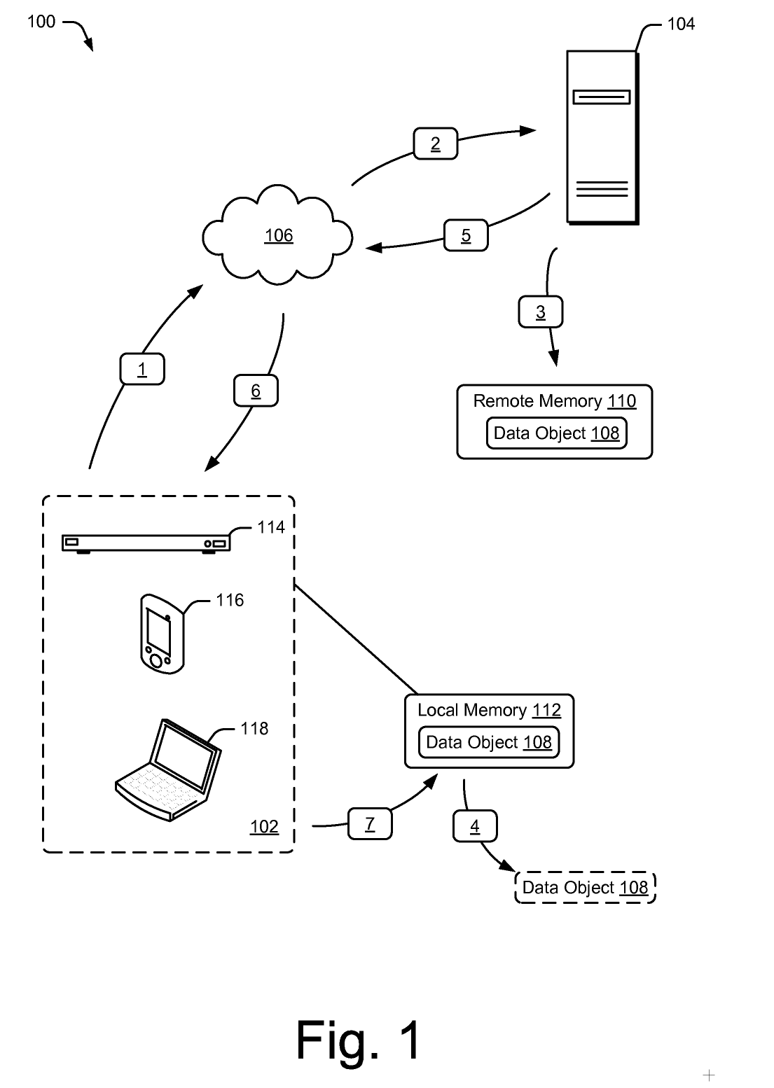

FIG. 1 illustrates an example environment 100 having virtual memory for a network-enabled computing device. Environment 100 includes a network-enabled computing device 102 and a virtual-memory device 104, which communicate through communication network 106. Generally, network-enabled computing device 102 provides a data object 108 to virtual-memory device 104 (arrow 1), which virtual-memory device 104 receives (arrow 2), stores in remote memory 110 (arrow 3), after which network-enabled computing device 102 may evict data object 108 from local memory 112 (arrow 4). When requested, virtual-memory device 104 provides data object 108 through communication network 106 (arrow 5) back to network-enabled computing device 102, which device 102 receives (arrow 6), and stores back into local memory 112 (arrow 7). In some embodiments, this storing and retrieving of data objects is performed transparently to a user and/or an application of network-enabled computing device 102.

Network-enabled computing device 102 can be any device capable of communicating over a communication network (e.g., network 106), though it is illustrated as one of a set-top box 114, a smart-phone 116, or a network-enabled laptop 118. Virtual-memory device 104 can be any device capable of communicating over a communication network and also of receiving, storing, and providing data, such as data object 108. While illustrated as a server computer, other devices are also contemplated, such as a desktop computer, laptop computer (assuming it has sufficient memory to provide virtual memory, such as to smart phone 116), and/or server farm. Communication network 106 may include the Internet, a local-area network, a wide-area network, a wireless network, and/or a USB hub, to name a few.

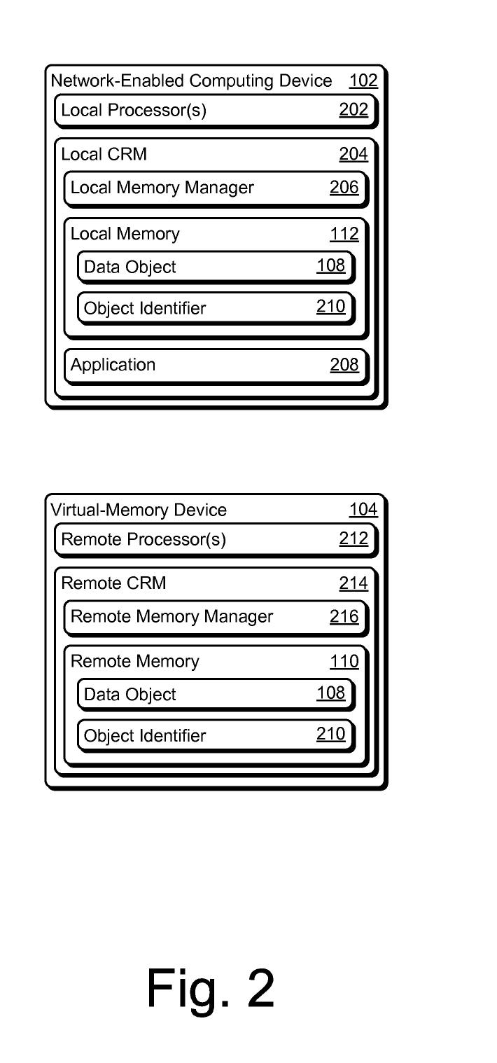

FIG. 2 illustrates example entities of network-enabled computing device 102 and virtual-memory device 104. Network-enabled computing device 102 includes local processor(s) 202 and local computer-readable media (CRM) 204. Local computer-readable media 204 contains local memory manager 206, local memory 112, and application 208. Local memory 112 includes internal and/or external (but local) memory and is capable of storing data objects 108 and object identifiers 210 (one of each shown for brevity). Each of data objects 108 has an associated and unique object identifier 210, which can be used to locate its associated data object 108. How object identifiers are created and used vary, and are described as part of processes discussed below.

Virtual-memory device 104 includes remote processor(s) 212 and remote computer-readable media (CRM) 214. Remote computer-readable media 214 contains remote memory manager 216 and remote memory 110. Remote memory manager 216 and local memory manager 206 act and interact to send, receive, and store (and evict, in some cases) data objects 108 effective to enable virtual memory for network-enabled computing device 102. Manners in which these and other entities illustrated in FIGS. 1 and 2 act are described in greater detail below.

Note that one or more of the entities shown in FIGS. 1 and 2 may be further divided, combined, and so on. Thus, the environment 100 of FIG. 1 (and as further described in part in FIG. 2) illustrates some of many possible environments capable of employing the described techniques.

Generally, any of the techniques and abilities described herein can be implemented using software, firmware, hardware (e.g., fixed-logic circuitry), manual processing, or a combination of these implementations. The entities of environment 100 generally represent software, firmware, hardware, whole devices or networks, or a combination thereof. In the case of a software implementation, for instance, the entities (e.g., local memory manager 206 and remote memory manager 216) represent computer-executable instructions (e.g., program code) that perform specified tasks when executed on a processor (e.g., CPU or CPUs). The program code can be stored in one or more computer-readable memory devices, such as computer-readable media 204 or 214. The features and techniques described herein are platform-independent, meaning that they may be implemented on a variety of commercial computing platforms having a variety of processors.

Example Processes

The following discussion describes techniques enabling virtual memory for a network-enabled computing device. Generally, these techniques enable a network-enabled computing device to behave as if it has more local memory than it actually has. This “virtual” memory is real memory at some remote location, but is virtual from the perspective of the network-enabled computing device. For example, space in local memory 112 that is occupied by data object 108 (or would be occupied if stored locally) is made available by storing data object 108 remotely. Network-enabled computing device 102 may either forgo storing data object 108, evict data object 108, or mark data object 108 for future eviction if memory space is needed. This remote storage, as well as future retrieval, can be transparent to a user or applications of network-enabled computing device 102.

Aspects of these processes may be implemented in hardware, firmware, software, or a combination thereof. These processes are shown as sets of blocks that specify operations performed, such as through one or more entities or devices, and are not necessarily limited to the order shown for performing the operations by the respective blocks. In portions of the following discussion reference may be made to environment 100 of FIG. 1 as well as entities of environment 100 illustrated in FIG. 2.

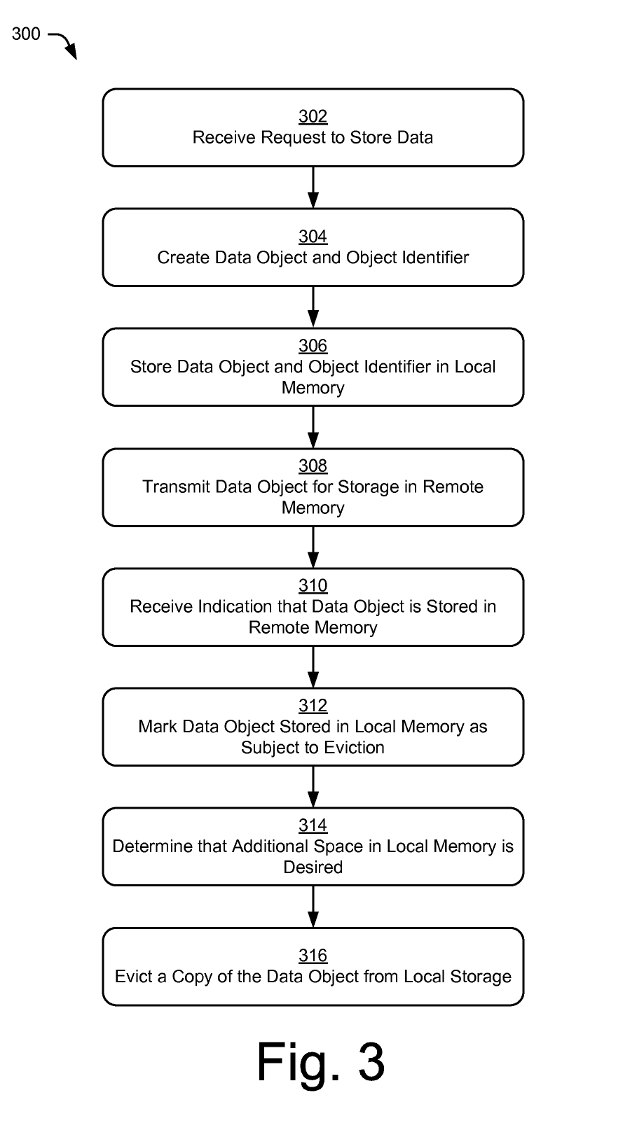

FIG. 3 is a flow diagram depicting an example process 300 for enabling virtual memory for a network-enabled computing device from the perspective of network-enabled computing device. Block 302 receives a request to store data, such as from a local application. The data may be a picture, address, song, or other piece or pieces of data. The request may be a request to store the data locally. This request for local storage may indicate that the application does not have information about, and has not been customized to request storage remotely. This is one example of how techniques described herein may be transparent to applications executing on network-enabled computing device 102.

By way of example, consider process 300 in the context of environment 100. Here local memory manager 206 receives, at block 302, a request to store data locally in local memory 112. The requesting entity (e.g., application 208 executing on network-enabled computing device 102) may or may not be aware of where or how the data will be stored. Here assume that application 208 is requesting to store data associated with a picture taken by a camera on smart phone 116, the data including a high-resolution version of the picture, a low-resolution of the picture (e.g., a thumb-nail), and metadata associated with the picture (e.g., time taken, notes about picture from user of the device, etc.). Assume also that the picture application is not aware of where and how the data will be stored, the request by the picture application being a conventional request to store data locally on smart phone 116.

Block 304 creates a data object having at least some of the data received at block 302. Optionally, block 304 may also create an object identifier associated with the data object. As noted previously, data object 108 can be uniquely identified by object identifier 210. In some cases object identifier 210 is a unique memory location in local memory 112 at which data object 108 is first stored.

Continuing the ongoing example, local memory manager 206 creates a data object having the data corresponding to the high-resolution version of the picture. In this case, the data object includes just the high-resolution version though it may also include the low-resolution version and/or the metadata associate picture, or the local memory manager may create different data objects for each of these versions and metadata.

Block 306 stores the data object in local memory, and in cases where the object identifier is created, also stores the object identifier in local memory. Local memory manager 206 may forgo storing the data object in local memory, instead relying solely on storing the data object in virtual memory via various acts of the 300 set forth below. In this example, however, local memory manager 206 stores data object 108 and its associated object identifier 210 in local memory 112.

Block 308 transmits the data object for storage in a remote memory, such as data object 108 across communication network 106 to virtual-memory device 104. Here local memory manager 206 transmits data object 108 along with object identifier 210, which is received by virtual-memory device 104. Actions by virtual-memory device 104 are described in greater detail below. Generally, however, virtual-memory device 104 receives, stores, and indicates this storage of data object 108 and, in some cases, object identifier 210. As will be discussed in greater detail below, the creation of object identifier 210 by local memory manager 206 is not required, instead, object identifier 210 may be created by virtual-memory device 104.

Block 310 receives an indication that the data object is now stored in remote memory. In cases where virtual-memory device 104 creates object identifier 210, block 310 receives object identifier 210 along with this indication. In this example, the indication simply indicates that the data object is stored because virtual-memory device 104 receives object identifier 210 as part of block 308. As noted for this example, data object 108 contains data representing the high-resolution version of the picture taken by the camera application on smart phone 116.

Block 312 marks the data object stored in local memory as subject to eviction. This assumes that the data object is stored in local memory prior to being transmitted at block 308. Continuing the ongoing example, the high-resolution picture is stored in local memory 112 with some indication that this data object 108 can be evicted. In this context, eviction represents deleting the data object 108 but not object identifier 210. This marking of data object 108 can be performed in various manners, such as marking the object identifier associated with that data object. By way of example, local memory manager 206 can record a Boolean operator indicating eviction or no eviction for each object identifier 210 stored in a table.

Block 314 determines that additional space in local memory is desired. This determining can include receiving a request to store additional data in local memory 112 and, responsive to this request, determining that additional memory needed to store this additional data is less than or equal to the space in local memory 112 being occupied by data object 108. For example, assume that a media-playing application requests to store data associated with a music video responsive to which local memory manager 206 determines that the data associated with the music video requires more memory than is available in local memory 112. This requirement for more memory than is available can be an absolute measure of memory space or be an amount of memory space that, were it occupied, would adversely affect performance of the device.

This determining can also include determining that data object 108 has not been accessed recently or is a least-recently accessed object of multiple different objects in local memory 112. This is one example of ongoing processes designed to delete unused data objects from local memory 112 so long as these data objects are stored remotely. Other processes are also contemplated including deleting data objects that have not been accessed within a predetermined period of time.

Block 316 evicts the local copy of the data object from local memory. Block 316 does so responsive to determining that additional space is needed or desired. Thus, when local memory manager 206 determines that additional space in local memory 112 is desired, local memory manager 206 evicts data object 108 from local storage 112. Continuing the ongoing example, local memory manager 206 evicts data object 108 representing the high-resolution photo noted above. As will be discussed in more detail below, data object 108 can later be retrieved if needed.

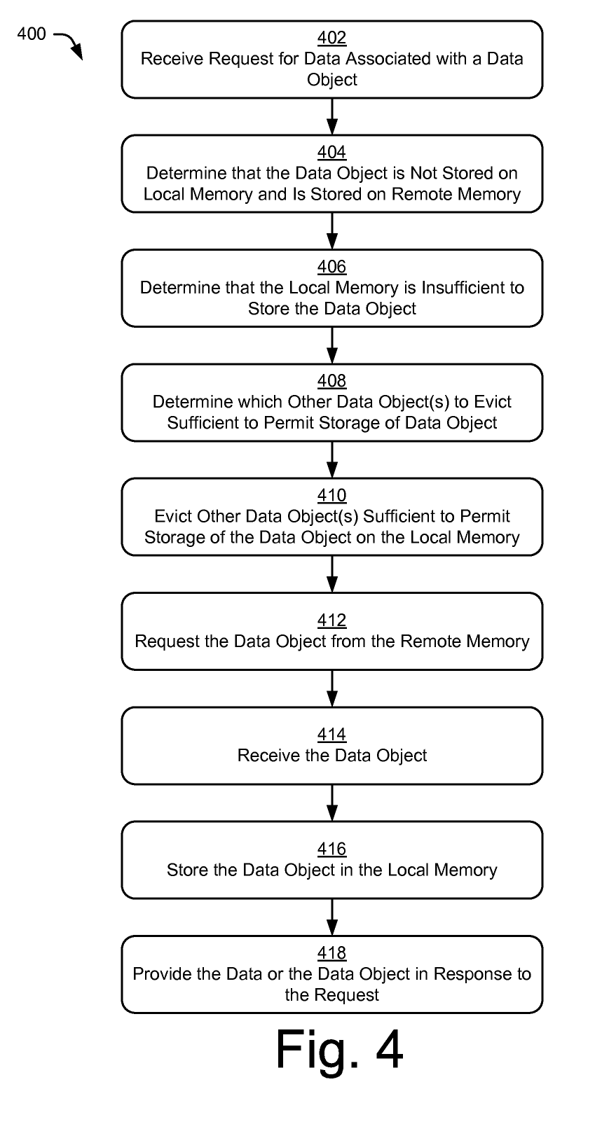

FIG. 4 is a flow diagram depicting an example process 400 for enabling virtual memory for a network-enabled computing device including retrieving data stored remotely. Block 402 receives a request for data associated with a data object. The request may come from a local application, such as application 208, which may or may not be aware of where the data is stored. Thus, these techniques can be generic to and independent as to the type of application or ability of the application. Assume that the request for data is the high-resolution data associated with the picture in the example above. This high-resolution data is stored as data object 108 in remote memory 110.

Assume for example, that a user opens up application 208, which in this case is a photo application, views various pictures taken by the user in the past, which the photo application displays as low-resolution thumbnails. The user then selects the low-resolution thumbnail associated with the high-resolution picture stored as data object 108 in the example given in the description of process 300. Responsive to this user selection the photo application on smart phone 116 requests data for that high-resolution picture so that the photo application can display it to the user. The photo application may or may not know that the high-resolution picture is stored locally or remotely or both.

Block 404 determines that the data object is not stored in local memory but that it is stored in remote memory. Block 404 may do so by analyzing the object identifier 210 associated with the requested data object. The object identifier 210 (or associated information) indicates that the data object is not stored in local memory 112 and is stored on the remote memory 110.

We assume for this case that the data object 108 has been evicted. Block 404 can determine this in various manners, for example, block 404 may do so by attempting to retrieve data object 108 (and failing) or by checking a table of object identifiers 210. The appropriate object identifier 210 may have associated information indicating that data object 108 has been evicted.

Continuing this example, local memory manager 206 determines that data object 108 is not stored locally. Unless there is some indication otherwise, local memory manager 206 assumes that the object 108 is still stored in remote memory 110.

Block 406 determines that the local memory is insufficient to store the data object. As is sometimes the case, local memory 112 may either have insufficient space to store data object 108 or insufficient space to store data object 108 without adversely affecting performance of the device. In some cases the object 108 is simply too large to store in local memory 112.

Block 408 determines which other data objects to evict sufficient to permit storage of the requested data object. Assuming that other data objects are stored in local memory 112, such as those stored with prior iterations of process 300, block 408 determines that one or more objects currently in local memory 112 will, if evicted, permit storage of the requested data object.

Determining which data objects to evict can be performed in various manners, including selecting those data objects that are the oldest or based on usage data of the user of network-enabled computing device 102. This usage data may indicate that one or more data objects 210 in local memory 112 have not been accessed for a period of time or are those least likely to be accessed by the user in the future, for example. Assume that local memory manager 206 analyzes various data objects in local memory 112 and determines that two particular data objects occupy sufficient space in local memory 112. Local memory manager 206 determines that one data object represents a music video that has not been accessed for 60 days and that the other data object represents a different high-resolution picture that has never been accessed and was the least recently taken picture by the user.

Block 410 evicts the other data object(s) sufficient to permit storage of the requested data object on the local memory. Here then, local memory manager 206 evicts data objects that are associated with the music video and the different high-resolution picture noted above to make room for requested data object 108.

Block 412 requests the requested data object from the remote memory. Local memory manager 206 requests data object 108 from virtual-memory device 104 through communication network 106. This request may include object identifier 210, which uniquely identifies requested data object 108. This requested data object contains data for the high-resolution picture selected, through application 208, by the user selecting a thumbnail of that picture.

Block 414 receives the requested data object. Here local memory manager 206 receives data object 108 having data for the high-resolution picture selected by the user through application 208, along with object identifier 210.

Block 416 stores the requested data object in the local memory. Local memory manager 206 stores data object 108 in local memory 112.

Block 418 provides the requested data or the requested data object in response to the request at block 402. For the ongoing example, the user selected the thumbnail of the picture, after which application 208 requested the high-resolution version of the picture from local memory manager 206, responsive to which local memory manager 206 provided the high-resolution version of the picture. In this example, the application and the user are unaware that the high-resolution version of the picture was stored remotely. Local memory manager 206 handled this request and various other actions sufficient to permit use of more memory without adversely affecting the user experience or requiring customizations to the application.

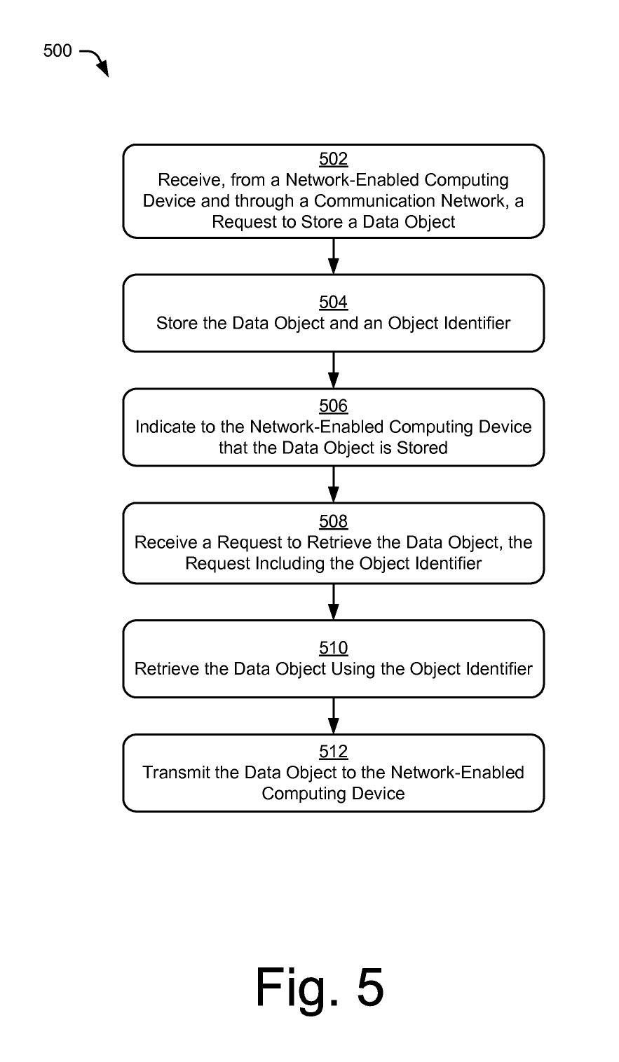

FIG. 5 is a flow diagram depicting an example process 500 for enabling virtual memory for a network-enabled computing device from the perspective of a virtual-memory device. Block 502 receives a request, from a network-enabled computing device and through a communication network, to store a data object. This request can be responsive to block 308 of process 300.

Block 504 stores the data object and an object identifier usable to retrieve that data object. As noted above the request may include the object identifier or block 504 may create the object identifier. By way of example, consider process 500 in the context of the prior-mentioned examples. Here virtual-memory device 104 receives the request at block 502, after which remote memory manager 216 stores data object 108 in remote memory 110 at block 504.

Block 506 indicates, to the network-enabled computing device, that the data object is stored. Block 506 may provide this indication in various ways, such as by providing object identifier 210. This indication can be received at block 310 of process 300. Here remote memory manager 216 indicates, across communication network 106 to network-enabled computing device 102, that data object 108 is stored. As noted previously, this indication may be used by network-enabled computing device 102 to evict a locally-stored copy of data object 108 from local memory 112.

Block 508 receives a request to retrieve the data object. This request may include the data object's unique object identifier. This request may be received soon after block 506 or much, much later. Here assume that data object 108 contains data for the high-resolution picture noted above. This picture could have been taken, and later (or immediately) stored by virtual-memory device 104 at block 504. Days, months, or even years later that network-enabled computing device 102 or some other device may request the high-resolution picture through a request for data object 108.

Note also that the requesting entity may be a different network-enabled computing device than the device that requested that the data object be stored. By way of example, consider that the user of smart phone 116, which is the device that took the picture and requested storage of data object 108, may be replaced. That same user buys another smart phone, transfers object identifier 210 to the new phone (which can be automatic, and can require few resources because of the small size of object identifier 210), and then requests to view the high-resolution version of the picture. This can easily be accomplished, even without a new picture application (or new version if on the same phone), being aware or having to be customized based on where the high-resolution data in data object 108 is stored. These techniques, then, can enable other benefits as well.

Block 510 retrieves the requested data object, which may be done using the object's identifier. Here remote memory manager 216 retrieves data object 108 from remote memory 110 using object identifier 210.

Block 512 transmits the requested data object to the requesting device, such as the network-enabled computing device that provided the data object for remote storage at block 502. As noted above, the requesting device can be a different device that the device that provided the data object previously.

In the ongoing example, virtual-memory device 104 provides data object 108 and object identifier 210 to network-enabled computing device 102 through communication network 106.

### CONCLUSION

This document describes techniques and apparatuses enabling virtual memory for network-enabled computing devices. This virtual memory can be nearly limitless, thereby permitting nearly unlimited use of memory by a network-enabled computing device. Further, these techniques and apparatuses may enable this virtual memory in a manner that is transparent to the user of, and even applications on, the network-enabled computing device. Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
transmitting, from a network-enabled computing device and across a communication network, a data object for storage in remote memory;
receiving, across the communication network, an indication that the data object is stored in the remote memory;
determining that additional space in local memory is desired; and
evicting the data object from the local memory to create at least a portion of the additional space.

2. The method as recited in claim 1, further comprising:
prior to the act of transmitting the data object, receiving a request to store data and creating the data object and an object identifier identifying the data object, the data object having the data requested to be stored;
prior to the act of determining that additional space in the local memory is desired, storing the data object and the object identifier in the local memory; and
prior to evicting the data object, marking the data object stored in the local memory as subject to eviction.

3. The method as recited in claim 2, wherein the request to store data requests that the data be stored in the local memory.

4. The method as recited in claim 1, further comprising evicting, from the local memory, other data objects that are stored in the local memory and the remote memory sufficient to create all of the additional space in the local memory.

5. The method as recited in claim 1, further comprising receiving a request to store data not associated with the data object in the local memory and wherein the act of determining includes determining that the additional space is needed to store the data.

6. The method as recited in claim 1, wherein the act of determining includes determining that the data object stored in the local memory is a least-recently accessed data object of multiple different data objects stored in the local memory.

7. The method as recited in claim 1, wherein the act of determining includes determining that the additional space in the local memory is desired based on the data object stored in the local memory having not been accessed within a predetermined period of time.

8. A method comprising:
receiving, from a network-enabled computing device and over a communication network, a request to store a data object;
storing the data object and an object identifier uniquely identifying the data object;
indicating, over the communication network and to the network-enabled computing device, that the data object is stored;
receiving, from the network-enabled computing device or another network-enabled computing device associated with a same user of the network-enabled computing device and over the communication network or another communication network, a request to retrieve the data object, the request including the object identifier;
retrieving the data object using the object identifier; and
transmitting the data object to the network-enabled computing device or the other network-enabled computing device over the communication network or the other communication network.

9. The method as recited in claim 8, wherein the act of receiving the request to retrieve the data object is from the network-enabled computing device and over the communication network.

10. The method as recited in claim 8, wherein the request to store the data object includes the object identifier.

11. The method as recited in claim 8, further comprising, following the act of receiving the request to store the data object, creating the object identifier, and wherein the act of indicating that the data object is stored includes providing the object identifier to the network-enabled computing device.

12. The method as recited in claim 8, wherein the request to retrieve the data object includes the object identifier.

13. A method comprising:
responsive to a request for data associated with a first data object and from an application executing on a network-enabled computing device, determining that the first data object is not stored in local memory of the network-enabled computing device and is stored in remote memory, the remote memory accessible by the network-enabled computing device through a communication network;
determining that available space on the local memory of the network-enabled computing device is insufficient to store the first data object;
evicting a second data object from the local memory of the network-enabled computing device to create additional available space in the local memory sufficient to permit storage of the first data object in the local memory;
requesting, through the communication network, the first data object stored in the remote memory;
receiving the first data object;
storing the first data object in the local memory; and
providing the first data object to the application.

14. The method as recited in claim 13, further comprising determining, prior to the act of evicting the second data object, which other data objects of multiple data objects stored in the local memory are sufficient to permit storage of the first data object if the other data objects are evicted, the other data objects including the second data object.

15. The method as recited in claim 14, wherein the act of determining which other data objects are sufficient to permit storage of the first data object includes selecting the other data objects based on usage data of a user of the network-enabled computing device.

16. The method as recited in claim 15, wherein the usage data indicates that the other data objects are those least likely to be accessed by the user.

17. The method as recited in claim 13, further comprising determining, prior to the act of evicting the second data object, that the second data object is a least-recently accessed data object of multiple data objects stored in the local memory.

18. The method as recited in claim 13, wherein the act of determining that the first data object is not stored in the local memory and is stored in the remote memory analyzes an identifier associated with the first data object, the identifier or information associated with the identifier indicating that the data object is not stored in the local memory and is stored in the remote memory.

19. The method as recited in claim 13, wherein the act of requesting the first data object from the remote memory includes providing an identifier associated with the first data object, the identifier uniquely identifying the first data object.

20. The method as recited in claim 13, wherein the request from the application requests that the data be retrieved from the local memory.
